(19) United States
(12) Patent Application Publication
(10) Pub. No.: US 2022/0154800 A1
(43) Pub. Date: May 19, 2022

(54) MOTION SENSOR MODULE AND MOVABLE PLATFORM

(71) Applicant: SZ DJI TECHNOLOGY CO., LTD., Shenzhen (CN)

(72) Inventors: Li JIANG, Shenzhen (CN); Kai CHEN, Shenzhen (CN); Xiaoxuan SUN, Shenzhen (CN)

(73) Assignee: SZ DJI TECHNOLOGY CO., LTD., Shenzhen (CN)

(21) Appl. No.: 17/589,900

(22) Filed: Feb. 1, 2022

Related U.S. Application Data
(63) Continuation of application No. PCT/CN2019/130746, filed on Dec. 31, 2019.

(51) Int. Cl. F16F 15/04; G01C 21/16; B64D 47/00; F16F 15/08; F16M 13/02

(52) U.S. Cl. CPC F16F 15/04; G01C 21/16; F16M 13/02; F16F 15/08; B64D 47/00

(57) ABSTRACT

A motion sensor module and a movable platform are provided. The motion sensor module may include: a motion sensor; a bearing frame for bearing the motion sensor; a mounting frame for connecting an external mechanism; and a plurality of dampers distributed around the bearing frame. The mounting frame and the bearing frame may be arranged opposite to each other at a distance interval. One end of each damper may be connected to the mounting frame, and the other end of each damper may be connected to the bearing frame. The axial stiffness of each damper may be greater than the radial stiffness thereof, and the axial direction of damper may extend obliquely outwards from the mounting frame.

### CROSS REFERENCE TO RELATED APPLICATION

The present application is a continuation of International Application No. PCT/CN2019/130746, filed Dec. 31, 2019, the entire contents of which being incorporated herein by reference in its entirety.

### TECHNICAL FIELD

The present disclosure relates to the technical field of motion sensor, and partict relates to a motion sensor module and a movable platform.

### BACKGROUND

The motion sensor has been extensively used in many industries. With the continuous development of technology, there are more and more types of motion sensors. The commonly used motion sensor mainly includes an acceleration sensor, a gyroscope, a geomagnetic sensor, and/or an inertial measurement unit (IMU), etc. The IMU contains contains an accelerometer and a gyroscope. The accelerometer is used to detect the acceleration component of an object, and the gyroscope is used to detect the angle information of the object. Generally, the IMU is installed at a center of gravity of the object. Because of its function of measuring the three-axis attitude angle (or angular rate) and acceleration of the object, the IMU is usually considered as the core component of navigation and guidance, and is widely used in vehicles, ships, robots, and aircraft that require the motion control.

Take the IMU as an example. The IMU module is critical for the flight control of an unmanned aerial vehicle. Due to the excitation of the aerodynamic load and the dynamic unbalanced load of the blades, the body of the unmanned aerial vehicle may experience a lot of high-frequency vibrations, and these high-frequency vibration components will be collected by the IMU, but these high frequency components are not helpful for the control system, so a vibration damping system of the motion sensor needs to be added.

Currently, the translational frequencies in the X, Y, and Z directions for most of the vibration damping systems are quite different, thereby resulting in great differences in the damping effects in each direction. For example, the rotation frequency is not high enough, especially for a FPV (First Person View) racing drone. The racing drone is a small unmanned aerial vehicle with a high racing speed and a short endurance. In the manual mode, the racing drone is directly controlled through gyro feedback. Thus, an extremely low control delay is required. If the rotation frequency is too low, it will cause the control delay of the gyroscope.

### SUMMARY

The present disclosure provides a motion sensor module and a movable platform, which helps to reduce the difference in vibration damping effects in each direction of the motion sensor module and reduce the control delay of the gyroscope to a certain extent.

A first aspect of the present disclosure provides a motion sensor module, the motion sensor module including:
a motion sensor;
a bearing frame for bearing the motion sensor;
a mounting frame for connecting an external mechanism, where the mounting frame is arranged opposite to the bearing frame at a distance interval; and
a plurality of dampers distributed around the bearing frame, one end of each damper being connected to the mounting frame, and the other end of each damper being connected to the bearing frame,
wherein the axial stiffness of each damper is greater than the radial stiffness thereof, and the axial direction of the damper extends obliquely outwards from the mounting frame.

A second aspect of the present disclosure provides a movable platform. The movably may include a body and a motion sensor module installed on the body; the motion sensor module may include:
a motion sensor;
a bearing frame for bearing the motion sensor;
a mounting frame for connecting an external mechanism, where the mounting frame is arranged opposite to the bearing frame at a distance interval; and
a plurality of dampers distributed around the bearing frame, one end of each damper being connected to the mounting frame, and the other end of each damper being connected to the bearing frame,
wherein the axial stiffness of each damper is greater than the radial stiffness thereof, and the axial direction of the damper extends obliquely outwards from the mounting frame.

The motion sensor module and the movable platform provided by some embodiments of the present disclosure may include the bearing frame for bearing the motion sensor, and a plurality of damping mechanisms or dampers that are arranged between the bearing frame and the mounting frame connected to the external mechanism; in this way, the vibrations of the motion sensor caused by the external mechanism is effectively reduced. The axial stiffness of each damping mechanism or damper is greater than the radial stiffness thereof, and the axial direction of the damping mechanism or damper extends obliquely outwards from the mounting frame. As such, the technical scheme of the present disclosure may reduce the difference in the damping effects in each direction of the motion sensor module, improving the control accuracy of the motion sensor. For a motion sensor including a gyroscope, it may reduce the control delay of the gyroscope to a certain extent.

It should be understood that the above general description and the following detailed description are only exemplary and explanatory and are not restrictive of the present disclosure.

### BRIEF DESCRIPTION OF THE DRAWINGS

In order to explain the technical features of embodiments of the present disclosure more clearly, the drawings used in the present disclosure are briefly introduced as follow. Obviously, the drawings in the following description are some exemplary embodiments of the present disclosure. Ordinary person skilled in the art may obtain other drawings and features based on these disclosed drawings without inventive efforts.

FIG. 1 illustrates a schematic structural diagram of a motions or module according to some embodiments of the present disclosure.

FIG. 2 illustrates an exploded view of a motion sensor module according to some embodiments of the present disclosure.

FIG. 3 illustrates a first transfer function diagram of a system translation of a motion sensor module according to some embodiments of the present disclosure.

FIG. 4 illustrates a second transfer function diagram of a system translation of a motion sensor module according to some embodiments of the present disclosure.

FIG. 5 illustrates a third transfer function diagram of a system translation of a motion sensor module according to some embodiments of the present disclosure.

FIG. 6 illustrates a first transfer function diagram of a system rotation of a motion sensor module according to some embodiments of the present disclosure.

FIG. 7 illustrates a second transfer function diagram of a system rotation of a motion sensor module according to some embodiments of the present disclosure.

FIG. 8 illustrates a third transfer function diagram of a system rotation of a motion sensor module according to some embodiments of the present disclosure.

### DETAILED DESCRIPTION

The technical solutions and technical features encompassed in the exemplary embodiments of the present disclosure will be described in detail in conjunction with the accompanying drawings in the exemplary embodiments of the present disclosure. Apparently, the described exemplary embodiments are part of embodiments of the present disclosure, not all of the embodiments. Based on the embodiments and examples disclosed in the present disclosure, all other embodiments obtained by those of ordinary skill in the art without inventive efforts shall fall within the protection scope of the present disclosure.

Here, exemplary embodiments will be described in detail, and examples thereof are shown in the accompanying drawings. The implementation manners described in the following exemplary embodiments do not represent all implementation manners consistent with the present disclosure. On the contrary, they are only examples of devices and methods consistent with some aspects of the disclosure as detailed in the appended claims. Further, the chart(s) and diagram(s) shown in the drawings are only examples, and does not necessarily include all components, elements, contents and/or operations/steps, nor does it have to be arranged in the described or specific order. For example, certain steps of the method may be performed in other orders or at the same time; some components/elements can also be disassembled, combined, or partially combined; therefore, the actual arrangement may be changed or modified according to actual conditions. In the case of no conflict, the components, elements, operations/steps, and other features disclosed in the embodiments may be combined with each other.

The motion sensor module of the present disclosure may be installed on the body of a movable platform in a detachable or non-detachable manner. The motion sensor module buffers the vibration of the body of the movable platform and prevent the vibration of the body from affecting the measurement accuracy of the motion sensor. The difference in the vibration damping effects in each translation direction of the motion sensor module is reduced, which improves the control accuracy of the motion sensor. For the motion sensor including a gyroscope, it may reduce the control delay of the gyroscope to a certain extent. The movable platform may include an unmanned aerial vehicle, a remote ground robot or the like.

### Example 1

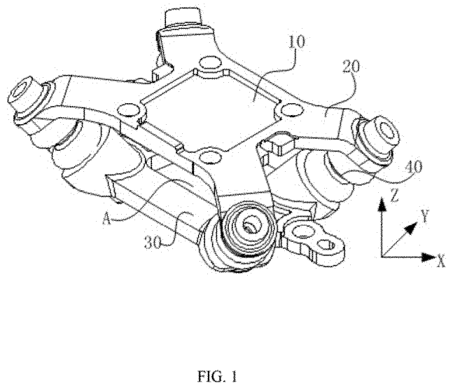

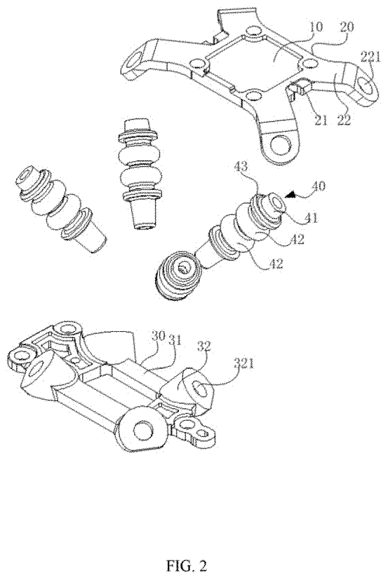

FIG. 1 illustrates a schematic structural diagram of a motion sensor module according to some embodiments of the present disclosure, and FIG. 2 illustrates an exploded view of the motion sensor module. The motion sensor module may be applied to a movable platform. As shown in FIG. 1 and FIG. 2, the motion sensor module may include a motion sensor 10, a bearing frame 20, a mounting frame 30, and a plurality of damping mechanisms 40.

The bearing frame 20 may be configured to bear the motion sensor 10. Taking the motion sensor 10 as an inertial measurement unit (IMU) as an example, the bearing frame 20 may correspond to an IMU board. The IMU board may be a printed circuit board assembly (PCBA) with the IMU.

The mounting frame 30 may be configured to connect to an external mechanism, and the mounting frame 30 and the bearing frame 20 may be arranged opposite to each other at a distance interval. In some embodiments, the mounting frame 30 may be configured to connect to an applicable movable platform. Taking the movable platform as an unmanned aerial vehicle as an example, the external mechanism connected to the mounting frame 30 may be the body of the unmanned aerial vehicle. In certain embodiments, the mounting frame 30 may be detachably connected with the external mechanism.

In some embodiments, the mounting frame 30 may be made of a low-density material such as plastic or carbon fiber, so as to reduce the weight of the motion sensor module as much as possible while ensuring the mechanical strength, which helps to achieve the lightweight of the movable platform. In the present disclosure, the specific structure of the mounting frame 30 is not limited, and those skilled in the art may design according to specific actual requirements.

The plurality of damping mechanisms or dampers 40 may be distributed around the bearing frame 20, one end of each damping mechanism or damper 40 may be connected to the mounting frame 30, and the other end of each damping mechanism 40 may be connected to the bearing frame 20. The plurality of damping mechanisms 40 may be symmetrically or evenly arranged around the bearing frame 20 to achieve better damping effects and to ensure the motion balance of the movable platform.

The number of damping mechanisms 40 is not limited, and those skilled in the art may set the number according to specific design requirements, and each two adjacent damping mechanisms 40 may have a respective preset distance. For the preset distance, those skilled in the art may set the preset distance according to specific design requirements.

The damping mechanism 40 may include at least an elastic material with a certain damping capability. For example, the elastic material may be foam, silica gel, rubber, or the like. The materials of the plurality of damping mechanisms 40 may be the same or different.

In some embodiments, for a single damping mechanism 40, it may only include an elastic portion, that is, the whole body of the damping mechanism 40 is composed of the elastic portion, and the elastic material adopted for the whole body is the same. For multiple damping mechanisms 40, the material adopted for each damping mechanism 40 is the same. For example, in one embodiment, one of the damping mechanisms 40 is made of silica gel, and the other damping mechanisms 40 are also made of silica gel. The silica gel has stable performance and strong anti-aging ability. In other embodiments, for a single damping mechanism 40, it may include an elastic portion and a rigid portion. Each damping mechanism 40 may include an elastic portion and a rigid portion. The materials corresponding to the rigid portions of the multiple damping mechanisms may be the same, and the materials corresponding to the elastic portions of the multiple damping mechanisms may be the same. For example, in one embodiment, one damping mechanism 40 includes a rigid portion of stainless steel and an elastic portion of silicone, while the other damping mechanisms 40 also include rigid portions of stainless steel and elastic portions of silicone. Optionally, the material of each damping mechanism 40 is the same, so as to ensure that the damping effects of each damping mechanism 40 is substantially the same as much as possible.

Of course, in certain embodiments, the materials of the multiple damping mechanisms 40 may be different. For example, in one embodiment, the material of one damping mechanism 40 is silica gel, while the materials of the other one or more damping mechanisms 40 are composed of stainless steel and silica gel. In another embodiment, the materials of some damping mechanisms 40 are silica gel, and the materials of the other damping mechanisms 40 are foam. The specific material of each damping mechanism 40 is not limited in the present disclosure and may be specifically selected according to actual conditions.

The axial stiffness of each damping mechanism 40 may be greater than the radial stiffness thereof, and the axial direction of the damping mechanism 40 may extend obliquely outwards from the bearing frame 20. In the present disclosure, the “axial direction” of the damping mechanism 40 may refer to a direction of the connection between two respective centers of the two end surfaces of the damping mechanism 40, pointing from the end connected to the mounting frame 30 to the end connected to the bearing frame 20, and the “radial direction” may refer to a direction perpendicular to the axis direction of the damping mechanism, that is, the direction of the connection between the two respective centers of the two end surfaces of the damping mechanism 40. In one embodiment, the axial stiffness of the damping mechanism 40 may be 120˜480 N/m, and the radial stiffness of the damping mechanism may be 2˜10 times as large as the axial stiffness. The axial stiffness and the radial stiffness of the damping mechanism may be measured by a method of deformation testing. The method of deformation testing may obtain stiffness by applying a counterweight to the test object and measuring the physical deformation of the test object.

For the damping mechanism 40, there are three translation directions, namely X, Y, Z as shown in FIG. 1. The greater the stiffness in a certain direction is, the higher the translational frequency corresponding to that direction is. The higher the translational frequency is, the worse the vibration damping effect is. The damping mechanism in the existing technology is arranged vertically, but for the damping mechanism whose axial stiffness is greater than the radial stiffness, this will cause the translational frequency in the Z direction to be higher than the translational frequencies in the X and Y directions. In some cases, the Z-direction damping effect is not good, which eventually causes the Z-direction accelerometer to exceed the range.

In order to solve the above problems, in the present disclosure, each damping mechanism 40 in the motion sensor module may be arranged obliquely to fully balance the translational frequencies of the three translation directions of X, Y, and Z, thereby reducing the difference in the translational frequencies in the three translation directions.

The axial direction of each damping mechanism 40 may extend obliquely outwards from the bearing frame 20. In some embodiments, the included angle between the axis direction of each damping mechanism and the mounting base may be in a range of approximately 20° to 60°, or 30° to 50°, or 35° to 45°. Since the axial stiffness of each damping mechanism 40 is greater than the radial stiffness thereof, the entire motion sensor module may be formed into a splayed structure, so that the rotation frequency of the damping mechanism 40 is increased. Taking the movable platform as an unmanned aerial vehicle and the motion sensor as an IMU (including a gyroscope) as an example, the IMU indirectly obtains the attitude of the unmanned aerial vehicle based on its own angle or attitude change. Therefore, the smaller the action delay between the IMU and the unmanned aerial vehicle is, the better the control is, that is, the faster the IMU follows the rotation when the unmanned aerial vehicle rotates, the more accurately the attitude of the unmanned aerial vehicle may be reflected. It is understandable that the higher the rotation frequency of the damping mechanism 40 is, the faster the IMU will follow the rotation when the unmanned aerial vehicle rotates, thereby reducing the delay of the IMU. When the rotation frequency is the highest, it is equivalent to that the IMU will not rotate relative to the unmanned aerial vehicle. In this scenario, the control delay will be the smallest, thereby improving the control accuracy of the IMU. In the present disclosure, by designing the motion sensor module as a splay-structured damping system, the rotation frequency of the motion sensor module is effectively increased, which improves the control accuracy of the IMU.

In some embodiments, the damping mechanism 40 may include at least one of a damping ball, a damping pad, a spring, or the like.

For example, the plurality of damping mechanisms 40 may each be a damping ball; or the plurality of damping mechanisms 40 may each be a spring; or the plurality of damping mechanisms 40 may each be a damping pad; or some of the damping mechanism 40 may each be a damping ball, and other damping mechanisms 40 may each be a spring; or some damping mechanisms 40 may each be a damping ball, and other damping mechanisms 40 may each be a damping pad; or some damping mechanisms 40 may each be a spring, and other damping mechanisms 40 may each be a damping pad; or one of the damping mechanisms 40 is a damping ball, one of the damping mechanisms 40 is a spring, and another of the damping mechanisms 40 is a damping pad; or a part of the plurality of damping mechanisms 40 may each be a combination of a damping ball and a spring, others may each be a combination of a damping ball and a damping pad; or a part of the plurality of damping mechanisms 40 may each be a combination of a damping ball, a spring, and a damping pad, and the other damping mechanisms 40 may each be one or two combinations of a damping ball, a spring or a damping pad; or a part of the plurality of damping mechanisms 40 may each be a combination of a spring and a damping pad, and the others may each be a combination of a damping pad and a damping ball, and so on. The different material selection of each damping mechanism 40 mainly results in different damping coefficients, and different damping coefficients may have different damping effects. The setting mode of each damping mechanism 40 may be set according to specific needs, which are not limited in the present disclosure.

The damping mechanism 40 may be connected between the bearing frame 20 and the mounting frame 30 to buffer the vibration transmitted by an external mechanism (such as the body of an unmanned aerial vehicle) to the bearing frame through the mounting frame 30 by generating tensile or compressive deformation, so as to reduce the vibration of the bearing frame 20 and further reduce the vibration of the motion sensor, which helps to improve the measurement accuracy of the motion sensor and ensures that the motion sensor does not have over-range and aliasing phenomena.

In some embodiments, the damping mechanism 40 may include a damping ball 42, which is a solid ball or a hollow ball. In one embodiment, the number of damping balls 42 of each damping mechanism 40 is one. In another embodiment, the number of damping balls 42 of each damping mechanism is two, and the two damping balls 42 are connected in series. When the damping ball is a solid ball, it helps to improve the connection strength between the bearing frame 20 and the mounting frame 30. When the damping ball is a hollow ball, the elastic deformation of the damping mechanism 40 is easier, which helps to improve the damping effects. The hollowed damping ball also effectively reduces the overall weight of the motion sensor module and fulfills the lightweight requirements. Considered comprehensively, in certain embodiments, a through hole is provided in the damping ball to ensure the damping effects and reduce the overall weight while ensuring the connection strength, which is helpful to realize the lightweight of the movable platform.

In certain embodiments, as shown in FIG. 1 and FIG. 2, the damping mechanism 40 may include a rigid portion 41 and two damping balls 42 connected in series with the rigid portion 41. In one embodiment, the rigid portion 41 may penetrate through the damping balls 42 to form a middle hollow structure. In another embodiment, the rigid portion 41 is hollow and the damping ball 42 is a hollow ball, but the rigid portion 41 does not pass through the damping balls 42. In yet another embodiment, only the rigid portion 41 is hollow, and the damping ball 42 is a solid ball. In still another embodiment, only the damping ball 42 is a hollow ball, and the rigid portion 41 is solid. In this way, the weight of the damping mechanism 40 can be reduced as much as possible, and the light-weight degree of the movable platform is greatly improved.

In addition, when the damping balls 42 are a double-ball design, and the damping frequencies in the X and Y directions are the same, the Z-direction damping frequency of the double-ball is lower, thus, the damping effects of the double-ball is better. Since the double-ball is two single balls connected in series, the stiffness in the Z direction will decrease.

In certain embodiments, the damping ball 42 may be made of rubber material, which may maintain a good damping performance at a low temperature.

In some embodiments, it is preferred that the ratio of the axial stiffness to the radial stiffness of the damping ball is 1.5-9. The ratio is mainly determined by the shape of the damping ball. Further, when an included angle between the axis of the damping ball along an axial direction of the damping mechanism and the horizontal plane or the mounting base is approximately 30°-50°, the damping ball may achieve the best effect in balancing the translational frequency of each translation direction and increasing the rotation frequency as much as possible. It should be noted that the axis of the damping ball is consistent with the axis of the damping mechanism, and the horizontal plane is a plane of the X and Y directions.

In order to better illustrate the technical effects of the present disclosure, data obtained through experiments is used as an example for description. For a tested IMU damping mechanism, when the damping mechanism is arranged vertically, the three translational frequencies in the X, Y and Z directions are 90 Hz, 100 Hz, and 160 Hz, respectively, and the three rotation frequencies (Roll, Pitch, Yaw) are 255 Hz, 180 Hz, 140 Hz, respectively. When the tested IMU damping mechanism is arranged in a splayed structure as disclosed in some embodiments of the present disclosure, as shown in FIG. 2, the three translational frequencies in the X, Y, and Z directions are 100 Hz, 107 Hz, 136 Hz, respectively, and the three rotation frequencies (Roll, Pitch, Yaw) are 265 Hz, 234 Hz, 180 Hz, respectively. Comparing the damping frequencies calculated under the two configurations, it can be seen that after adopting the splayed arrangement of the damping mechanism, the difference of the translational frequencies in the three directions has dropped from 70 Hz to 36 Hz, and the damping frequencies in the Pitch and Yaw directions have increased by 40 to 50 Hz.

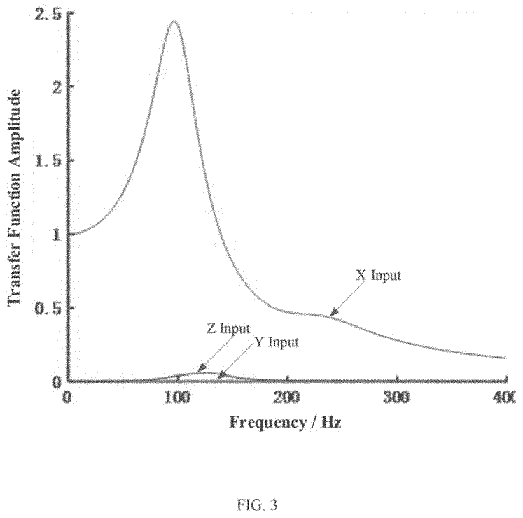

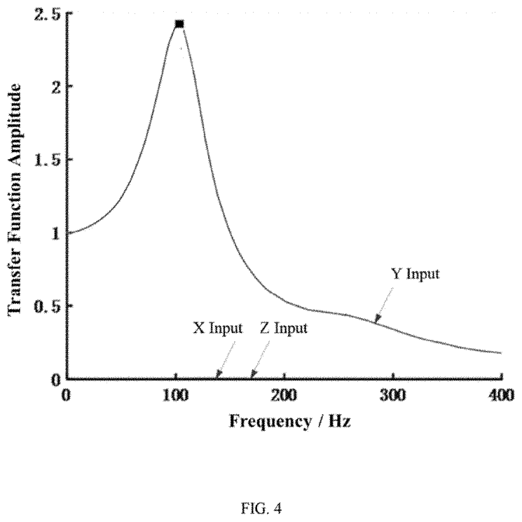

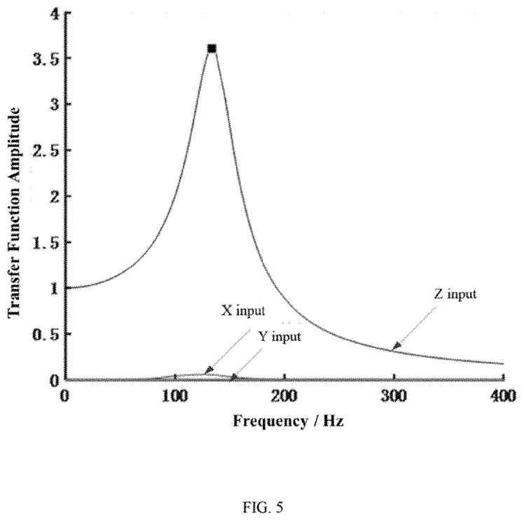

FIG. 3 illustrates a first transfer function diagram of a system translation of a motion sensor module according to some embodiments of the present disclosure. As shown in FIG. 3, the Y input curve infinitely approaches the horizontal axis and basically coincides with the horizontal axis, and the Z input curve is also close to the horizontal axis. FIG. 4 illustrates a second transfer function diagram of a system translation of a motion sensor module according to some embodiments of the present disclosure. As shown in FIG. 4, the X input curve and the Z input curve are infinitely close to the horizontal axis and basically coincide with the horizontal axis. FIG. 5 illustrates a third transfer function diagram of a system translation of a motion sensor module according to some embodiments of the present disclosure. As shown in FIG. 5, the X input curve is close to the horizontal axis, and the Y input curve is infinitely close to the horizontal axis and basically coincides with the horizontal axis. It can be seen from FIG. 3 to FIG. 5 that the damping frequency of each translation direction may be relatively close, and the difference may be small.

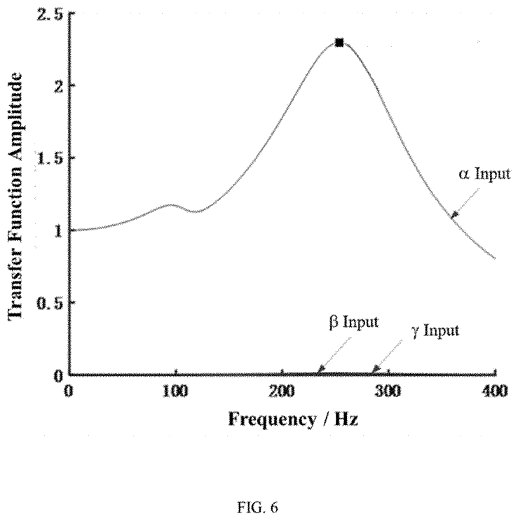

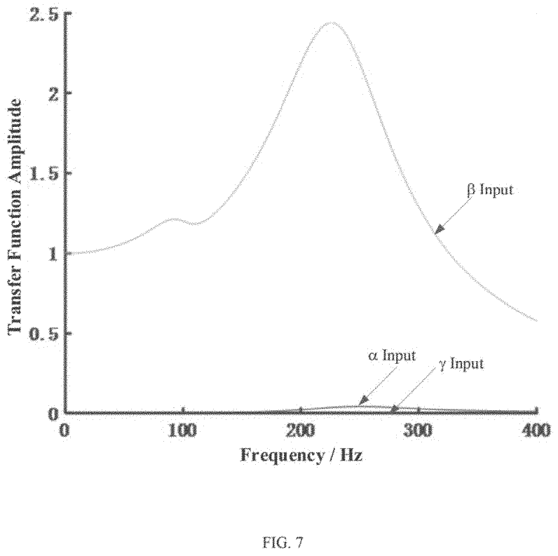

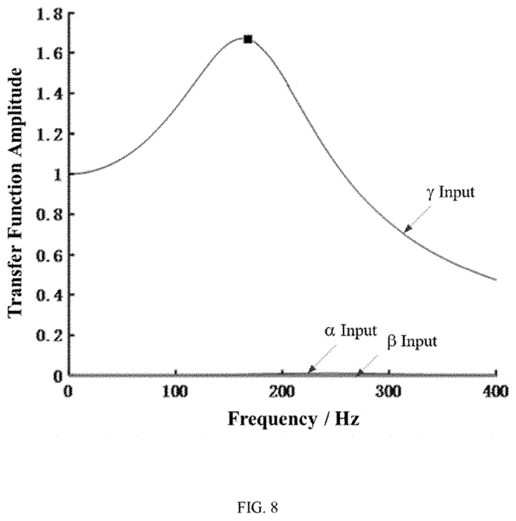

FIG. 6 illustrates a first transfer function diagram of a system rotation of a motion sensor module according to some embodiments of the present disclosure. As shown in FIG. 6, the β input curve and the y input curve are infinitely close to the horizontal axis and basically coincide with the horizontal axis. FIG. 7 illustrates a second transfer function diagram of a system rotation of a motion sensor module according to some embodiments of the present disclosure. As shown in FIG. 7, the α input curve is close to the horizontal axis, and the γ input curve is infinitely close to the horizontal axis and they basically coincide with the horizontal axis. FIG. 8 illustrates a third transfer function diagram of a system rotation of a motion sensor module according to some embodiments of the present disclosure. As shown in FIG. 8, the α input curve is close to the horizontal axis, and the β input curve is infinitely close to the horizontal axis and they basically coincide with the horizontal axis. It can be seen from FIG. 6 to FIG. 8 that the rotation frequency in each direction may be higher.

The motion sensor module provided in some embodiments of the present disclosure includes the bearing frame for bearing the motion sensor and a plurality of damping mechanisms arranged between the bearing frame and the mounting frame connected to the external mechanism. The vibration of the motion sensor caused by the external mechanism is effectively reduced. The axial stiffness of the damping mechanism is greater than the radial stiffness thereof, and the axial direction of the damping mechanism extends obliquely outwards from the bearing frame. As a result, the technical scheme disclosed in some embodiments of the present disclosure may reduce the difference in the damping effects of the motion sensor module in each direction and improve the control accuracy of the motion sensor. For a motion sensor including a gyroscope, the instant technical scheme may reduce the control delay of the gyroscope to a certain extent.

Further, in some embodiment, the number of the damping mechanisms 40 may be 2N, where N≥1. 2N damping mechanisms 40 are symmetrically arranged with the center line of the bearing frame 20 as the symmetry axis. The center line of the bearing frame is a line parallel to the bearing base and passing through a center of the bearing base. That is to say, the number of damping mechanisms 40 is an even number, and the even number of damping mechanisms 40 are symmetrically arranged with the center line of the bearing frame 20 as the symmetry axis X1. This configuration is beneficial to improve the balance of the two sides of the bearing frame 20, so that the forces on both sides of the bearing frame 20 are balanced as much as possible, and so as to improve the motion balance of the movable platform.

It is understandable that the number of the damping mechanisms 40 may be four, six, eight, twelve, etc., which is not limited herein. Those skilled in the art may comprehensively consider the cost and the vibration damping effect to choose an appropriate number of damping mechanisms 40.

The weight of the N damping mechanisms 40 located on one side of the symmetry axis may be the same as the weight of the N damping mechanisms 40 located on the other side of the symmetry axis. The weights of the damping mechanism 40 located on both sides of the symmetry axis may be the same, which may further ensure the balance of the motion sensor module and the motion balance of the movable platform. For an unmanned aerial vehicle, the symmetrical arrangement of the damping mechanisms may improve flight safety.

It should be noted that, generally, the respective structures of the bearing frame 20 and the mounting frame 30 may be also an axisymmetric structure. As such, the motion balance of the movable platform is strictly guaranteed.

In some embodiments, the plurality of damping mechanisms 40 may be distributed symmetrically with respect to the central axis of the bearing frame 20. The central axis of the bearing frame is a line perpendicular to the bearing base and passing through a center of the bearing base. It may also achieve the effect of improving the motion balance of the movable platform. In addition, in certain embodiments, the inclination angle of each damping mechanism 40 the mounting base is the same, thereby further improving the balance of the motion sensor module.

In some embodiments, a retreat space A for accommodating the movement of the bearing frame 20 relative to the mounting frame 30 may be formed between the mounting frame 30 and the bearing frame 20. The movement of the bearing frame 20 relative to the mounting frame 30 refers to the residual amount of movement of the bearing frame 20 after the vibration is damped by the damping mechanism 40 during the occurrence of vibration.

When the bearing frame 20 is installed on the mounting frame 30, when vibration occurs, the damping mechanism 40 may generate elastic deformation, and the bearing frame 20 may at least move in a vertical direction and a horizontal direction relative to the mounting frame 30. The vertical direction (i.e., Z direction as shown in FIG. 1) refers to the direction perpendicular to the mounting frame 30 and the bearing frame 20, and the horizontal direction (including the X and Y directions) is the direction perpendicular to the vertical direction. By setting the retreat space A, the bearing frame 20 may be prevented from colliding with the mounting frame 30 during the movement of the bearing frame 20 relative to the mounting frame 30. Otherwise, the collision may reduce the vibration damping effect of the damping mechanism 40.

In certain embodiments, a through hole or groove for accommodating the bearing frame 20 may be provided on the mounting frame 30, and the through hole or groove forms the retreat space A. A retreat distance of 2 mm or more is reserved in each direction of the movement of the bearing frame 20 relative to the mounting frame 30 to form the retreat space A. In one embodiment, when the vibration does not occur, the vertical distance between the hole wall of the through hole and the side edge of the bearing frame 20 in the moving direction is 2 mm or more than 2 mm. In another embodiment, when the vibration does not occur, the vertical distance between the side wall of the groove and the side edge of the bearing frame 20 is 2 mm or more than 2 mm, and the distance between the bottom wall of the groove and the surface of the bearing frame 20 facing the mounting frame 30 is 2 mm or more than 2 mm. Of course, it should be noted that the reserved retreat distance is not limited to at least 2 mm. It may be determined according to the deformation characteristics of the selected damping mechanism 40. When the selected damping mechanism 40 has a large degree of elastic deformation, the retreat distance should be relatively large. If the degree of deformation of the damping mechanism 40 is relatively small, the retreat distance may be slightly small.

In some embodiments, the mounting frame 30 may be in the shape of a frame. For example, as shown in FIG. 1, the mounting frame 30 is in the shape of a rectangular frame. The hollow (i.e., through hole) forms the retreat space for the movement of the bearing frame 20.

By designing the mounting frame 30 into a frame shape, in addition to providing the retreat space A, the weight of the mounting frame 30 may also be reduced as much as possible to improve the lightweight of the movable platform.

The connection between the damping mechanism 40 and the mounting frame 30 may include at least one of the following: a snap connection, a screw connection, an adhesive bonding, a hinge connection, and a pivot connection; and/or, the connection between the damping mechanism 40 and the bearing frame 20 may include at least one of the following: a snap connection, a screw connection, an adhesive bonding, a hinge connection, and a pivot connection.

In some embodiments, the connection between the damping mechanism 40 and the mounting frame 30 may be a detachable connection such as a detachable snap connection, a screw connection, etc. The screw connection may be that the damping mechanism 40 and the mounting frame 30 are connected by a bolt or other fasteners. In some embodiments, the connection between the damping mechanism 40 and the mounting frame 30 may be a non-detachable connection such as a non-detachable snap connection, an adhesive bonding, or the like. In some embodiments, the damping mechanism 40 and the mounting frame 30 may be rotatably connected together by a hinge or pivot connection. Specifically, the connection mode may be selected according to actual needs, which will not be limited herein.

In some embodiments, the connection between the damping mechanism 40 and the bearing frame 20 may be a detachable connection such as a detachable snap connection, a screw connection, etc. In one embodiment, the damping mechanism 40 and the bearing frame 20 are connected by a bolt or other fasteners. In some embodiments, the connection between the damping mechanism 40 and the bearing frame 20 may be a non-detachable connection such as a non-detachable snap connection, an adhesive bonding, or the like. In some embodiments, the damping mechanism 40 and the bearing frame 20 may be rotatably connected together by a hinge or pivot connection. The connection mode between the damping mechanism 40 and the mounting frame 30 and the connection mode between the damping mechanism 40 and the bearing frame 20 may be the same or different, which are not particularly limited herein.

Any of the above connection modes may ensure the reliable connection of the damping mechanism 40 with the bearing frame 20 and the mounting frame 30. When the damping mechanism 40 is detachably connected to the bearing frame 20 and/or the mounting frame 30, the damping mechanism 40 may be conveniently replaced, repaired, or adjusted in position. When the damping mechanism 40 is non-detachably connected to the bearing frame 20 and/or the mounting frame 30, the stability of the damping mechanism 40 after being connected may be further improved. When the damping mechanism 40 is rotatably connected with the bearing frame 20 and the mounting frame 30, the connection angles between the damping mechanism 40 and the bearing frame 20 and the mounting frame 30 may be effectively adjusted, which may conveniently meet various operating conditions and structural requirements and has the better flexibility.

In some embodiments, the connection angle between the damping mechanism 40 and the bearing frame 20 is adjustable, and the connection angle between the damping mechanism 40 and the mounting frame 30 is adjustable. Optionally, the damping mechanism 40 and the bearing frame 20 may be rotatably connected (for example, through a hinged, pivoted, and ball hinged connection), and the damping mechanism 40 and the mounting frame 30 may be rotatably connected (for example, through a hinged, pivoted, or ball hinged connection). Through the adjustable connection angles between the damping mechanism 40 and the bearing frame 20 and the mounting frame 30, the connection angles of the damping mechanism 40 between the bearing frame 20 and the mounting frame 30 may be flexibly adjusted, which may meet various operating conditions or structural needs and has a good flexibility.

It is understandable that the installation device of the motion sensor module in some embodiments may further include a locking device (not shown in the figure). The locking device may be provided between the damping mechanism 40 and the bearing frame 20 to lock the connection angle between the damping mechanism 40 and the bearing frame 20; and/or, the locking device may be provided between the damping mechanism 40 and the mounting frame 30 to lock the connection angle between the damping mechanism 40 and the mounting frame 30. The locking device may be any locking device used to lock a rotating pair in the art. For example, when the rotating pair is a ball hinge, the locking device may be a bolt, and the end of the bolt is used to press against one of the rotating members to prevent the one of the rotating members from rotating relative to the other rotating member through the friction force, thereby achieving locking. If the connection angles between the damping mechanism 40 and the bearing frame 20 and the mounting frame 30 need to be adjusted again, it only needs to loosen the bolt in the opposite direction. There are many specific structures and locking methods of the locking device, and those skilled in the art may adopt corresponding locking devices according to actual needs and design requirements, which are not limited herein.

The connection angles between the damping mechanism 40 and the bearing frame 20 and the mounting frame 30 may be fixed by the locking device, so as to ensure the stability after connection. When it is necessary to adjust the connection angles between the damping mechanism 40 and the bearing frame 20 and the mounting frame 30 again, it just needs to unlock the locking device, which is convenient to operate.

It should be noted that when it is necessary to fix the connection angles between the damping mechanism 40 and the bearing frame 20 and the mounting frame 30, only one of the damping mechanisms 40 needs to be fixed by the locking device. Of course, when all the damping mechanisms 40 are locked by the locking device, the stability after locking is the best.

### Example Two

On the basis of the EXAMPLE 1, the structures of the bearing frame 20, the mounting frame 30, and the damping mechanism 40 will be further described in detail. In some embodiments, as shown in FIGS. 1 and 2, the bearing frame 20 may include a bearing base 21 and a plurality of connecting portions 22 extending from an edge of bearing base 21. The connecting portion 22 is used to detachably connect the damping mechanism 40. The motion sensor 10 may be arranged in the middle of the bearing base 21. In one embodiment, the bearing base 21 may be rectangular, and the connecting portion 22 may be formed by extending from the corner edge of the bearing base 21.

Further, as shown in FIGS. 1 and 2, the connecting portion 22 may be provided with a connecting hole 221, and one end of the damping mechanism 40 may be sleeved in the connecting hole 221. One end of the damping mechanism 40 may be sleeved in the connecting hole 221, and at the end is provided with an anti-disengaging portion 43 that prevents the damping mechanism 40 from disengaging from the connecting hole 221. The connecting portion 22 may be bent and extend from the bearing base 21 towards the outside of the bearing base 21. More specifically, the connecting portion 22 may be bent and extend downwards (i.e., towards the mounting frame 30) from the bearing base 21 towards the outside of the bearing base 21. In this way, a spacing distance between the bearing frame 20 and the mounting frame 30 may be shorten while the angle between the axis of the damping mechanism 40 and the horizontal direction is maintained, thereby reducing the height of the motion sensor module. For an unmanned aerial vehicle, on the basis of ensuring the technical effects described above, it may also effectively reduce the vertical height of the unmanned aerial vehicle, which is conducive to the miniaturization of the unmanned aerial vehicle.

Similarly, the mounting frame 30 may include a mounting base 31 and a plurality of supporting portions 32 extending from an edge of the mounting base 31. The supporting portion 32 may be used to detachably connect the damping mechanism 40. Optionally, the supporting portion 32 may be provided with a mounting hole 321, and one end of the damping mechanism 40 may be embedded in the mounting hole 321. The mounting hole 321 of the supporting portion 32 and the one end of the damping mechanism 40 may be detachably connected by a fastener, such as a bolt and a gasket. The damping mechanism 40 and the supporting portion 32 may be detachably connected, so that the damping mechanism 40 can be removed from the mounting frame 30, which facilitates replacement or reassembly of the damping mechanism 40. In one embodiment, the mounting base 31 may be rectangular, and the supporting portion 32 may be formed by extending from the corner edge of the mounting base 31.

The supporting portion 32 may extend obliquely from the mounting base 31 towards the outside of the mounting base 31. More specifically, the supporting portion 32 may be bent and extend upwards (i.e., towards the bearing frame 20) from the mounting base 31 towards the outside of the mounting base 31. In this way, a spacing distance between the bearing frame 20 and the mounting frame 30 may be shorten while the angle between the axis of the damping mechanism 40 and the horizontal direction is maintained, thereby reducing the height of the motion sensor module. For an unmanned aerial vehicle, on the basis of ensuring the technical effects described above, it may also effectively reduce the vertical height of the unmanned aerial vehicle, which is conducive to the miniaturization of the unmanned aerial vehicle.

In addition, the mounting base 31 may be arranged in parallel with the bearing base 21. In one embodiment, both the mounting base 31 and the bearing base 21 may be in the shape of a plate, and the two are arranged in parallel, which may effectively save space and cause no space waste.

### Example Three

The present disclosure also provides a movable platform, which may be an unmanned aerial vehicle, a robot, such as a remotely controlled ground robot, or a gimbal. The movable platform may include a body and a motion sensor module mounted on the body. The motion sensor module may include a motion sensor 10, a bearing frame 20, a mounting frame 30 and a plurality of damping mechanisms 40.

The bearing frame 20 may be configured to bear the motion sensor 10. Taking the motion sensor 10 as an IMU as an example, the bearing frame 20 may correspond to an IMU board. The IMU board may be a printed circuit board assembly (PCBA) with the IMU.

The mounting frame 30 may be configured to connect to an external mechanism, and the mounting frame 30 and the bearing frame 20 may be arranged opposite to each other at a distance interval.

The plurality of damping mechanisms 40 may be distributed around the bearing frame 20, one end of each damping mechanism 40 may be connected to the mounting frame 30, and the other end of each damping mechanism 40 may be connected to the bearing frame 20. The axial stiffness of each damping mechanism 40 may be greater than the radial stiffness thereof, and the axial direction of the damping mechanism 40 may extend obliquely outwards from the bearing frame 20. In the present disclosure, the “axial direction” of the damping mechanism 40 may refer to a direction of the connection between the two ends of the damping mechanism 40 or between two respective centers of the two ends of the damping mechanism 40, and the “radial direction” may refer to a direction perpendicular to the direction of the connection between the two ends of the damping mechanism 40.

The axial direction of each damping mechanism 40 may extend obliquely outwards from the bearing frame 20. Since the axial stiffness of each damping mechanism 40 is greater than the radial stiffness thereof, the entire motion sensor module may be formed into a splayed structure, so that the rotation frequency of the damping mechanism 40 may be increased. Taking the movable platform as an unmanned aerial vehicle and the motion sensor as an IMU (including a gyroscope) as an example, the IMU indirectly obtains the attitude of the unmanned aerial vehicle based on its own angle or attitude change. Therefore, the smaller the action delay between the IMU and the unmanned aerial vehicle is, the better the control is, that is, the faster the IMU follows the rotation when the unmanned aerial vehicle rotates, the more accurately the attitude of the unmanned aerial vehicle may be reflected. It is understandable that the higher the rotation frequency of the damping mechanism 40 is, the faster the IMU will follow the rotation when the unmanned aerial vehicle rotates, thereby reducing the delay of the IMU. When the rotation frequency is the highest, it is equivalent to that the IMU will not rotate relative to the unmanned aerial vehicle. In this scenario, the control delay will be the smallest, thereby improving the control accuracy of the IMU. In the present disclosure, by designing the motion sensor module as a splay-structured damping system, the rotation frequency of the motion sensor module is effectively increased, which improves the control accuracy of the IMU.

In some embodiments, the damping mechanism 40 may include at least one of a damping ball, a damping pad, a spring, or the like.

For example, the plurality of damping mechanisms 40 may each be a damping ball; or the plurality of damping mechanisms 40 may each be a spring; or the plurality of damping mechanisms 40 may each be a damping pad; or some of the damping mechanism 40 may each be a damping ball, other damping mechanisms 40 may each be a spring; or some damping mechanisms 40 may each be a damping ball, and other damping mechanisms 40 may each be a damping pad; or some damping mechanisms 40 may each be a spring, and other damping mechanisms 40 may each be a damping pad; or one of the damping mechanisms 40 is a damping ball, one of the damping mechanisms 40 is a spring, and another of the damping mechanisms 40 is a damping pad; or a part of the plurality of damping mechanisms 40 may each be a combination of a damping ball and a spring, others may each be a combination of a damping ball and a damping pad; or a part of the plurality of damping mechanisms 40 may each be a combination of a damping ball, a spring, and a damping pad, and the other damping mechanisms 40 may each be one or two combinations of a damping ball, a spring or a damping pad; or a part of the plurality of damping mechanisms 40 may each be a combination of a spring and a damping pad, and the others may each be a combination of a damping pad and a damping ball, and so on. The different material selection of each damping mechanism 40 mainly results in different damping coefficients, and different damping coefficients may have different damping effects. The setting mode of each damping mechanism 40 may be set according to specific needs, which is not limited in the present disclosure.

The damping mechanism 40 may be connected between the bearing frame 20 and the mounting frame 30 to buffer the vibration transmitted by an external mechanism (such as the body of an unmanned aerial vehicle) to the bearing frame through the mounting frame 30 by generating tensile or compressive deformation, so as to reduce the vibration of the bearing frame 20 and further reduce the vibration of the motion sensor. This configuration helps to improve the measurement accuracy of the motion sensor and ensures that the motion sensor does not have over-range and aliasing phenomena.

In some embodiments, the damping mechanism 40 may include a damping ball 42, which is a solid ball or a hollow ball. In one embodiment, the number of damping balls 42 of each damping mechanism 40 is one. In another embodiment, the number of damping balls 42 of each damping mechanism is two, and the two damping balls 42 are connected in series. When the damping ball is a solid ball, it helps to improve the connection strength between the bearing frame 20 and the mounting frame 30. When the damping ball is a hollow ball, the elastic deformation of the damping mechanism 40 is easier, which helps to improve the damping effects. The hollowed damping ball also effectively reduces the overall weight of the motion sensor module and fulfills the lightweight requirements. Considered comprehensively, in certain embodiments, a through hole is provided in the damping ball to ensure the damping effects and reduce the overall weight while ensuring the connection strength, which is helpful to realize the lightweight of the movable platform.

In certain embodiments, as shown in FIG. 1 and FIG. 2, the damping mechanism 40 may include a rigid portion 41 and two damping balls 42 connected in series with the rigid portion 41. In one embodiment, the rigid portion 41 may penetrate through the damping balls 42 to form a middle hollow structure. In another embodiment, the rigid portion 41 is hollow and the damping ball 42 is a hollow ball, but the rigid portion 41 does not pass through the damping balls 42. In yet another embodiment, only the rigid portion 41 is hollow, and the damping ball 42 is a solid ball. In still another embodiment, only the damping ball 42 is a hollow ball, and the rigid portion 41 is solid. In this way, the weight of the damping mechanism 40 may be reduced as much as possible, and the light-weight degree of the movable platform is greatly improved.

In addition, when the damping balls 42 is a double-ball design, and the damping frequencies in the X and Y directions are the same, the Z-direction damping frequency of the double-ball is lower, thus, the damping effects of the double-ball is better. Since the double-ball is two single balls connected in series, the stiffness in the Z direction will decrease.

In certain embodiments, the damping ball 42 may be made of rubber material, which may maintain a good damping performance at a low temperature.

The movable platform provided by some embodiments of the present disclosure may include a motion sensor module. The motion sensor module may include the bearing frame for bearing the motion sensor and a plurality of damping mechanisms that are arranged between the bearing frame and the mounting frame connected to the external mechanism; in this way, the vibration of the motion sensor caused by the external mechanism is effectively reduced. The axial stiffness of each damping mechanism may be greater than the radial stiffness thereof, and the axial direction of the damping mechanism may extend obliquely outwards from the bearing frame. As such, the technical scheme of the present disclosure may reduce the difference in the damping effects in each direction of the motion sensor module and improve the control accuracy of the motion sensor. For a motion sensor including a gyroscope, the instant technical scheme may reduce the control delay of the gyroscope to a certain extent.

Further, in some embodiment, the number of the damping mechanisms 40 may be 2N, where N≥1. 2N damping mechanisms 40 are symmetrically arranged with the center line of the bearing frame 20 as the symmetry axis. That is to say, the number of damping mechanisms 40 is an even number, and the even number of damping mechanisms 40 are symmetrically arranged with the center line of the bearing frame 20 as the symmetry axis X1, which is beneficial to improve the balance of the two sides of the bearing frame 20, so that the forces on both sides of the bearing frame 20 are balanced as much as possible, so as to improve the motion balance of the movable platform.

The weight of the N damping mechanisms 40 located on one side of the symmetry axis may be the same as the weight of the N damping mechanisms 40 located on the other side of the symmetry axis.

It should be noted that, generally, the respective structures of the bearing frame 20 and the mounting frame 30 may be also an axisymmetric structure. As such, the motion balance of the movable platform is strictly guaranteed.

In some embodiments, the plurality of damping mechanisms 40 may be distributed symmetrically with respect to the central axis of the bearing frame 20. In addition, in certain embodiments, the inclination angle of each damping mechanism 40 is the same.

In some embodiments, the mounting frame 30 may be in the shape of a frame. For example, as shown in FIG. 1, the mounting frame 30 is in the shape of a rectangular frame. The hollow center (i.e., through hole) forms a retreat space for the movement of the bearing frame 20.

The connection between the damping mechanism 40 and the mounting frame 30 may include at least one of the following: a snap connection, a screw connection, an adhesive bonding, a hinge connection, and a pivot connection; and/or, the connection between the damping mechanism 40 and the bearing frame 20 may include at least one of the following: a snap connection, a screw connection, an adhesive bonding, a hinge connection, and a pivot connection.

In some embodiments, the connection angle between the damping mechanism 40 and the bearing frame 20 is adjustable, and the connection angle between the damping mechanism 40 and the mounting frame 30 is adjustable.

It is understandable that the installation device of the motion sensor module in some embodiments may further include a locking device (not shown in the figure). The locking device may be provided between the damping mechanism 40 and the bearing frame 20 to lock the connection angle between the damping mechanism 40 and the bearing frame 20; and/or, the locking device may be provided between the damping mechanism 40 and the mounting frame 30 to lock the connection angle between the damping mechanism 40 and the mounting frame 30.

The structure and function of the motion sensor module in the movable platform provided in some embodiments of the present example may be the same as those of the EXAMPLE 1. For details, reference may be made to the description of the EXAMPLE 1, which will not be repeated herein for conciseness.

Example 4

On the basis of the EXAMPLE 3, the structures of the bearing frame 20, the mounting frame 30, and the damping mechanism 40 will be further described in detail. In some embodiments, as shown in FIGS. 1 and 2, the bearing frame 20 may include a bearing base 21 and a plurality of connecting portions 22 extending from an edge of bearing base 21. The connecting portion 22 may be used to detachably connect the damping mechanism 40.

Further, as shown in FIGS. 1 and 2, the connecting portion 22 may be provided with a connecting hole 221, and one end of the damping mechanism 40 may be sleeved in the connecting hole 221. The connecting portion 22 may be bent and extend downwards (i.e., towards the mounting frame 30) from the bearing base 21 towards the outside of the bearing base 21.

Similarly, the mounting frame 30 may include a mounting base 31 and a plurality of supporting portions 32 extending from an edge of the mounting base 31. The supporting portion 32 may be used to detachably connect the damping mechanism 40. Specifically, the supporting portion 32 may be provided with a mounting hole 321, and one end of the damping mechanism 40 may be embedded in the mounting hole 321.

The supporting portion 32 may extend obliquely from the mounting base 31 towards the outside of the mounting base 31.

In addition, the mounting base 31 may be arranged in parallel with the bearing base 21.

The structure and function of the motion sensor module in the movable platform provided in some embodiments of the present example may be the same as those of the EXAMPLE 2. For details, reference may be made to the description of the EXAMPLE 2, which will not be repeated herein for conciseness.

In the several embodiments provided by the present disclosure, the mutual coupling or direct coupling or communication connection shown or discussed may be indirect coupling or communication connection through some interfaces, devices, or units, and may be in the form of electrical or mechanical or other forms.

Unless otherwise defined, all technical and scientific terms used herein have the same meaning as commonly understood by those skilled in the technical field of the present disclosure. The terms used herein are only for the purpose of describing specific embodiments and are not intended to limit of the disclosure. As used in this disclosure and the appended claims, the singular forms “a,” “an,” and “the” are intended to include the plural forms as well, unless the context clearly indicates otherwise. It should also be understood that the term “and/or” and the symbol “/” as used herein refer to and encompass any or all possible combinations of one or more associated listed items. The term “approximately” or “about” as used herein means that within the acceptable error range, those skilled in the art may solve the technical problem within a certain error range, and basically achieve the technical effect. Terms such as “connected” or “linked” may include any direct and indirect means of connection. For example, when it is described in the disclosure that a first element is connected to a second element. it means that the first element may be directly connected to the second element, or the first element is indirectly connected to the second device through other elements. Phrases such as “a plurality of,” “multiple,” or “several ” mean two and more.

It should be noted that in the instant disclosure, relational terms such as “first” and “second”, etc. are used herein merely to distinguish one entity or operation from another entity or operation without necessarily requiring or implying any such actual relationship or order between such entities or operations. The terms “comprise/comprising”, “include/including”, “has/have/having” or any other variants thereof are intended to cover non-exclusive inclusion, so that a process, method, article, or device that includes a series of elements includes not only those elements, but also other elements that are not explicitly listed, or also includes elements inherent to such processes, methods, articles, or equipment. If there are no more restrictions, the element defined by the phrase, such as “comprising a . . . ”, “including a . . . ” does not exclude the presence of additional identical elements in the process, method, article, or equipment that includes the element.

Finally, it should be noted that the above embodiments/examples are only used to illustrate the technical features of the present disclosure, not to limit them; although the present disclosure has been described in detail with reference to the foregoing embodiments and examples, those of ordinary skill in the art should understand that: the technical features disclosed in the foregoing embodiments and examples can still be modified, some or all of the technical features can be equivalently replaced, but, these modifications or replacements do not deviate from the spirit and scope of the disclosure.

What is claimed is:

1. A movable platform, comprising a body and a motion sensor module mounted on the body, wherein the motion sensor module comprises:
a motion sensor,
a bearing frame for bearing the motion sensor,
a mounting frame for connecting an external mechanism, the mounting frame being arranged opposite to the bearing frame at a distance interval, and
a plurality of dampers distributed around the bearing frame, one end of each of the dampers being connected to the mounting frame, and another end of each of the dampers being connected to the bearing frame,
wherein an axial stiffness of each of the dampers is greater than a radial stiffness thereof, and an axial direction of each of the dampers extends obliquely outwards from the mounting frame.

2. The movable platform of claim 1, wherein the bearing frame comprises a bearing base and a plurality of connecting portions extending from an edge of the bearing base, and the plurality of connecting portions is configured to detachably connect to the plurality of dampers, respectively.

3. The movable platform of claim 2, wherein each of the connecting portions is provided with a connecting hole, and one end of one of the dampers is sleeved in the connecting hole.

4. The movable platform of claim 2, wherein each of the connecting portions extends from the bearing base towards an outside of the bearing base and an end of each of the connecting portions away from the bearing base is bent toward the mounting frame.

5. The movable platform of claim 2, wherein the mounting frame comprises a mounting base and a plurality of supporting portions extending from an edge of the mounting base, and the plurality of supporting portions is configured to detachably connect to the plurality of dampers, respectively.

6. The movable platform of claim 5, wherein each of the supporting portions is provided with a mounting hole, and one end of one of the dampers is embedded in the mounting hole.

7. The movable platform of claim 5, wherein each of the supporting portions extends obliquely from the mounting base towards an outside of the mounting base.

8. The movable platform of claim 5, wherein the mounting base and the bearing base are arranged in parallel to each other.

9. The movable platform of claim 1, wherein the number of the dampers is 2N, wherein N is an integer greater than or equal to 1, and the 2N dampers are symmetrically arranged with respect to a center line of the bearing frame.

10. The movable platform of claim 5, wherein an included angle between the axial direction of each of the dampers and the mounting base is in a range of 30° to 50°.

11. The movable platform of claim 9, wherein a weight of the N dampers located on one side of the center line and a weight of the N dampers located on the other side of the center line are the same.

12. The movable platform of claim 1, wherein each of the dampers comprises at least one of a damping ball, a damping pad, or a spring.

13. The movable platform of claim 12, wherein each of the dampers comprises the damping ball, and the damping ball is a solid ball or a hollow ball; and
wherein each of the dampers include one damping ball, or at least two damping balls connected in series.

14. The movable platform of claim 13, wherein a ratio of an axial stiffness to a radial stiffness of the damping ball is 1.5-9.

15. The movable platform of claim 13, wherein an included angle between an axis of the damping ball along the axial direction of the damper and a mounting base of the mounting frame is in a range of 30° to 50°.

16. The movable platform of claim 5, wherein an inclination angle of each of the dampers relative to the mounting base is the same.

17. The movable platform of claim 1, wherein:
a connection between each of the dampers and the mounting frame comprises at least one of a snap connection, a screw connection, an adhesive bonding, a hinge connection, or a pivot connection; and/or
a connection between each of the dampers and the bearing frame comprises at least one of a snap connection, a screw connection, an adhesive bonding, a hinge connection, or a pivot connection.

18. The movable platform of claim 1, wherein a connection angle between each of the dampers and the bearing frame is adjustable, and a connection angle between each of the dampers and the mounting frame is adjustable.

19. The movable platform of claim 18, further comprising a locking device, wherein:
each of the dampers is rotatably connected with the bearing frame, and each of the dampers is rotatably connected with the mounting frame; and
the locking device is provided between each of the dampers and the bearing frame for locking the connection angle between the each of the dampers and the bearing frame; and/or, the locking device is provided between each of the dampers and the mounting frame for locking the connection angle between the each of the dampers and the mounting frame.

20. The movable platform of claim 1, wherein a material of each of the dampers is the same or different; wherein the motion sensor comprises an inertial measurement unit; wherein the mounting frame is frame-shaped with a hollow center and is detachably connected to the body; and wherein the movable platform is an unmanned aerial vehicle, a robot, or a gimbal.
